(19) United States
(12) Patent Application Publication
(10) Pub. No.: US 2010/0214310 A1
(43) Pub. Date: Aug. 26, 2010

(54) IMAGE PROCESSING APPARATUS, IMAGE PROCESSING METHOD, RECORDING MEDIUM, AND INTEGRATED CIRCUIT

(76) Inventors: Yasuhiro KUWAHARA, Osaka (JP); Haruo Yamashita, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/709,581

(22) Filed: Feb. 22, 2010

(30) Foreign Application Priority Data
Feb. 23, 2009 (JP) 2009-038884

(51) Int. Cl. G09G 5/02; G09G 5/10

(52) U.S. Cl. 345/590; 345/690

(57) ABSTRACT

An image processing apparatus transforms a color signal of a first color space defined by a predetermined standard into a color signal of a second color space which is defined according to display characteristics of a display device and has a color gamut wider than a color gamut of the first color space, and outputs the transformed color signal. More specifically, the image processing apparatus includes: a first correction unit configured to, for each of color values making up the color signal of the first color space, correct a color value exceeding a first upper limit to the first upper limit and correct a color value falling below a first lower limit to the first lower limit, the first upper limit and the first lower limit being necessary for expressing the color gamut of the second color space; a color space transformation unit configured to transform the color signal of the first color space corrected by said first correction unit, into the color signal of the second color space; and a second correction unit configured to, for each of color values making up the color signal of the second color space generated by said color space transformation unit, (i) correct a color value exceeding a second upper limit to the second upper limit and correct a color value falling below a second lower limit to the second lower limit, and (ii) output the corrected values, the second upper limit and the second lower limit being values which can be displayed by the display device.

### BACKGROUND OF THE INVENTION

(1) Field of the Invention

The present invention relates to an image processing apparatus and an image processing method for performing processing such as color transformation for display devices, including plasma displays and liquid crystal displays.

(2) Description of the Related Art

In recent years, there is a widespread of display devices which are capable of displaying image signals compliant with standards such as DCI/P3 and Adobe RGB which express color gamut wider than that of standards such as BT.709 and sRGB. Hereinafter, the color gamut expressed by the BT.709 and sRGB is referred to as “normal gamut”, and the color gamut expressed by DCI/P3 and Adobe RGB, for example, is referred to as “wide gamut”.

There has been a problem, however, that when an image signal expressed in the wide gamut is input into a display device which only supports image signals expressed in the normal gamut, the display device displays an image having saturation different from that of the original image because of the inability to perform correct color reproduction.

To solve this problem, there is a method of expressing each color value (red component, green component, blue component) in the normal gamut by using 0.0 to 1.0, and expressing color values outside the normal gamut by using a value larger than 1.0 or a value smaller than 0.0 (that is, a negative value). Expressing the color values in the wide gamut by extending the possible color values of the normal gamut (0.0 to 1.0) allows favorable color reproduction even with legacy display devices which do not support the image signals in the wide gamut. It is to be noted that when each color value in the normal gamut is expressed in eight bits, 0.0 is equivalent to 0 while 1.0 is equivalent to 255.

On the other hand, image processing apparatuses which support the image signals in the wide gamut employ a method as disclosed in Japanese Unexamined Patent Application Publication No. 2006-148606 (Patent Reference 1) to handle the extended color values (color values larger than 1.0 and negative color values). FIG. 11 shows an image processing apparatus 10 disclosed in Patent Reference 1. The image processing apparatus 10 shown in FIG. 11 includes an image input correction unit P1, a first transformation circuit P2, a first γ (gamma) correction circuit P3, a second transformation circuit P4, a second γ correction circuit P5, a display driver circuit P6, and a display device P7.

According to Patent Reference 1, the first transformation circuit P2 transforms an input video signal, from a Y/C signal into an RGB signal, for example. The first γ correction circuit P3 corrects the RGB signal, which has been output by the first transformation circuit P2, into a linear video signal (RGB signal). The second transformation circuit P4 transforms the video signal, which has been corrected by the first γ correction circuit P3, from a first color space into a second color space which supports the color gamut of the display device P7.

Up to this stage, the color value of the video signal can take a value not only in the range from 0.0 to 1.0, but also a value larger than 1.0 or a negative value. Therefore, the second transformation circuit P4 clips the color value of a video signal outside the range from 0.0 to 1.0, and outputs the resulting video signal.

With the conventional structure, however, the second transformation circuit P4 first transforms the video signal into a video signal of the color space which supports the color gamut of the display device P7, and then clips the color value outside the range from 0.0 to 1.0, so that the video signal is transformed into a video signal which only has a color value that can be displayed by the display device P7. For this reason, when a video signal which cannot be displayed by the display device P7 is input into the image processing apparatus 10, clipping triggers a significant saturation drop.

FIG. 12 is a diagram for explaining the cause of saturation drop in the conventional image processing apparatus 10. For ease of explanation, FIG. 12 shows two primary colors (for example, two dimensions with R and G) while it is normally three RGB primary colors (three dimensions). In FIG. 12, the vertical axis represents luminance, and the horizontal axis represents saturation. Colors on the vertical axis are gray scale colors, and the saturation increases with increase in the lateral (horizontal) distance from the vertical axis.

On the plane of FIG. 12, the primary color vectors of the first color space are expressed as R₁^{→} (red vector) and G₁^{→} (green vector). That is to say, the region surrounded by broken lines in FIG. 12 is equivalent to the “normal gamut”. Further, the primary color vectors of the second color space are expressed as R₂^{→} (red vector) and G₂^{→} (green vector). That is to say, the region surrounded by solid lines in FIG. 12 is equivalent to the “wide gamut”. Here, the sign “→ (vector)” represents a sign provided on the immediately-preceding letter.

Each color in the normal gamut (each point in the region surrounded by broken lines) can be expressed by a combination of 0.0≦R₁^{→}≦1.0 and 0.0≦G₁^{→}≦1.0 (R₁^{→}, G₁^{→}). Further, each color in the wide gamut (including the normal gamut) (each point in the region surrounded by solid lines) can be expressed by a combination of 0.0≦R₂^{→}≦1.0 and 0.0≦G₂^{→}) 1.0 (R₂^{→}, G₂^{→}). Black (point B in FIG. 12) is expressed as (R₁^{→}, G₁^{→})=(R₂^{→}, G₂^{→})=(0, 0). White (point W in FIG. 12) is expressed as (R₁^{→}, G₁^{→})=(R₂^{→}, G₂^{→})=(1, 1).

Moreover, the point X in FIG. 12 can be expressed as (R₁^{→}, G₁^{→})=(0.7, −0.35) using the primary color vectors R₁^{→} and G₁^{→} of the first color space. Similarly, the point X can also be expressed as (R₂^{→}, G₂^{→})=(0.5, −0.15) using the primary color vectors R₂^{→} and G₂^{→} of the second color space. That is to say, extending each primary color vector to a value smaller than 0.0 (negative value) or a value larger than 1.0 makes it possible to express colors outside the color gamuts.

The color space transformation performed by the second transformation circuit P4 of Patent Reference 1 is a process of re-expressing, for example, the point X (R₁^{→}, G₁^{→})=(0.7, −0.35) expressed using the primary color vectors R₁^{→} and G₁^{→} of the first color space, into (R₂^{→}, G₂^{→})=(0.5, −0.15) using the primary color vectors R₂^{→} and G₂^{→} of the second color space. This means that although this process changes the way of expressing the color, it does not change the color itself.

After this process, the second transformation circuit P4 clips the magnitudes (color values) of the primary color vectors and G₂^{→} of the second color space to a range which can be displayed by the display device P7 (that is, within the region surrounded by solid lines).

In other words, with the upper limit of 1.0 and the lower limit of 0.0, values outside the range of 0.0 to 1.0 are rounded off (replaced with the upper limit or the lower limit). In the example of FIG. 12, the point X (R₂^{→}, G₂^{→})=(0.5, −0.15) is mapped, in parallel to G₂^{→}, to the point X′ (R₂^{→}, G₂^{→})=(0.5, 0.0) on R₂^{→}.

With this process, the display device P7 displays a color (point X′) different from the input color (point X). However, as it is clear from FIG. 12, the color corresponding to the point X′ has saturation lower than the saturation of the color corresponding to the point X (the point X′ is on the left side of the point X (the point X′ is closer to the vertical axis)).

### SUMMARY OF THE INVENTION

The present invention has been conceived to solve the above problem, and it is an object of the present invention to provide an image processing apparatus and an image processing method for, even when a signal which cannot be displayed by a display device is input, suppressing saturation drop caused by clipping.

The image processing apparatus according to an aspect of the present invention is an image processing apparatus which transforms a color signal of a first color space defined by a predetermined standard into a color signal of a second color space which is defined according to display characteristics of a display device and has a color gamut wider than a color gamut of the first color space, and outputs the transformed color signal. More specifically, the image processing apparatus includes: a first correction unit configured to, for each of color values making up the color signal of the first color space, correct a color value exceeding a first upper limit to the first upper limit and correct a color value falling below a first lower limit to the first lower limit, the first upper limit and the first lower limit being necessary for expressing the color gamut of the second color space; a color space transformation unit configured to transform the color signal of the first color space corrected by the first correction unit, into the color signal of the second color space; and a second correction unit configured to, for each of color values making up the color signal of the second color space generated by the color space transformation unit, (i) correct a color value exceeding a second upper limit to the second upper limit and correct a color value falling below a second lower limit to the second lower limit, and (ii) output the corrected values, the second upper limit and the second lower limit being values which can be displayed by the display device.

According to the present invention, performing the first correction prior to the color space transformation makes it possible to suppress saturation drop to an extent greater than the conventional techniques.

As an aspect, the image processing apparatus may further include a gamma transformation unit configured to perform, based on a gamma transformation curve determined in accordance with the predetermined standard, gamma transformation on the color signal of the first color space corrected by the first correction unit, and the color space transformation unit may be configured to transform the color signal of the first color space, on which the gamma transformation unit has performed the gamma transformation, into the color signal of the second color space. With this, it is possible to limit in advance the range of the signal to be processed by the gamma transformation unit, thereby allowing reduction in circuit scale.

As another aspect, the first correction unit may be configured to simultaneously perform gamma transformation and correct the color values making up the color signal of the first color space, the gamma transformation being performed using a gamma transformation curve which is determined in accordance with the predetermined standard and which matches an output value exceeding the first upper limit with the first upper limit and matches an output value falling below the first lower limit with the first lower limit. With this, it is possible to achieve faster processing and circuit scale reduction.

As another aspect, the image processing apparatus may further include a gamma transformation unit configured to perform gamma transformation on the color signal of the first color space based on a gamma transformation curve determined in accordance with the predetermined standard, and the first correction unit may be configured to correct the color values making up the color signal of the first color space on which the gamma transformation unit has performed the gamma transformation.

Further, the color signal of the first color space and the color signal of the second color space may be expressed using primary color vectors each corresponding to one of the color values. The first upper limit and the first lower limit may be an upper limit and a lower limit of each of the primary color vectors of the first color space, the upper limit and the lower limit being necessary for combining the primary color vectors of the first color space so as to express each of the primary color vectors of the second color space.

Furthermore, the color space transformation unit may be configured to transform the color signal of the first color space into the color signal of the second color space using a color transformation matrix determined according to the display characteristics of the display device. The first upper limit and the first lower limit may be determined based on an inverse matrix of the color transformation matrix.

Further, the first upper limit and the first lower limit may be determined for each of a red component, a green component, and a blue component which make up the color values.

Furthermore, the first upper limit may be a sum of positive components in a row of the inverse matrix, and the first lower limit may be a sum of negative components in a row of the inverse matrix.

The image processing method according to an aspect of the present invention is an image processing method of transforming a color signal of a first color space defined by a predetermined standard into a color signal of a second color space which is defined according to display characteristics of a display device and has a color gamut wider than a color gamut of the first color space, and outputting the transformed color signal. More specifically, the image processing method includes: for each of color values making up the color signal of the first color space, correcting a color value exceeding a first upper limit to the first upper limit and correcting a color value falling below a first lower limit to the first lower limit, the first upper limit and the first lower limit being necessary for expressing the color gamut of the second color space; transforming the color signal of the first color space corrected in the correcting, into the color signal of the second color space; and for each of color values making up the color signal of the second color space generated in the transforming, correcting a color value exceeding a second upper limit to the second upper limit and correcting a color value falling below a second lower limit to the second lower limit, and outputting the corrected values, the second upper limit and the second lower limit being values which can be displayed by the display device.

The computer-readable recording medium according to an aspect of the present invention is a computer-readable recording medium on which a program is recorded which causes a computer to transform a color signal of a first color space defined by a predetermined standard into a color signal of a second color space which is defined according to display characteristics of a display device and has a color gamut wider than a color gamut of the first color space, and to output the transformed color signal. More specifically, the program causes the computer to execute: for each of color values making up the color signal of the first color space, correcting a color value exceeding a first upper limit to the first upper limit and correcting a color value falling below a first lower limit to the first lower limit, the first upper limit and the first lower limit being necessary for expressing the color gamut of the second color space; transforming the color signal of the first color space corrected in the correcting, into the color signal of the second color space; and for each of color values making up the color signal of the second color space generated in the transforming, correcting a color value exceeding a second upper limit to the second upper limit and correcting a color value falling below a second lower limit to the second lower limit, and outputting the corrected values, the second upper limit and the second lower limit being values which can be displayed by the display device.

The integrated circuit according to an aspect of the present invention is an integrated circuit which transforms a color signal of a first color space defined by a predetermined standard into a color signal of a second color space which is defined according to display characteristics of a display device and has a color gamut wider than a color gamut of the first color space, and outputs the transformed color signal. More specifically, the integrated circuit includes: a first correction unit configured to, for each of color values making up the color signal of the first color space, correct a color value exceeding a first upper limit to the first upper limit and correct a color value falling below a first lower limit to the first lower limit, the first upper limit and the first lower limit being necessary for expressing the color gamut of the second color space; a color space transformation unit configured to transform the color signal of the first color space corrected by the first correction unit, into the color signal of the second color space; and a second correction unit configured to, for each of color values making up the color signal of the second color space generated by the color space transformation unit, (i) correct a color value exceeding a second upper limit to the second upper limit and correct a color value falling below a second lower limit to the second lower limit, and (ii) output the corrected values, the second upper limit and the second lower limit being values which can be displayed by the display device.

According to the image processing apparatus and the image processing method of the present invention, performing the first correction prior to the color space transformation makes it possible to suppress saturation drop to an extent greater than the conventional image processing apparatuses and image processing methods.

### FURTHER INFORMATION ABOUT TECHNICAL BACKGROUND TO THIS APPLICATION

The disclosure of Japanese Patent Application No. 2009-038884 filed on Feb. 23, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram of an image processing apparatus according to Embodiment 1 of the present invention;

FIG. 2 is a flowchart showing an operation of an image processing apparatus according to Embodiment 1 of the present invention;

FIG. 3 is a diagram explaining a result of an operation of an image processing apparatus according to Embodiment 1 of the present invention;

FIG. 4 is a diagram showing a first gamma transformation curve according to Embodiment 1 of the present invention;

FIG. 5 is a diagram showing a second gamma transformation curve according to Embodiment 1 of the present invention;

FIG. 6 is a diagram showing a first gamma transformation curve according to a variation of Embodiment 1;

FIG. 7 is a block diagram of an image processing apparatus according to Embodiment 2 of the present invention;

FIG. 8 is a flowchart showing an operation of an image processing apparatus according to Embodiment 2 of the present invention;

FIG. 9 is a diagram showing a first gamma transformation curve according to Embodiment 2 of the present invention;

FIG. 10 is a block diagram of an image processing apparatus according to Embodiment 3 of the present invention;

FIG. 11 is a block diagram of a conventional image processing apparatus; and

FIG. 12 is a diagram explaining a result of an operation of a conventional image processing apparatus.

### DESCRIPTION OF THE PREFERRED EMBODIMENT(S)

Hereinafter, embodiments of the present invention are described with reference to the drawings.

### Embodiment 1

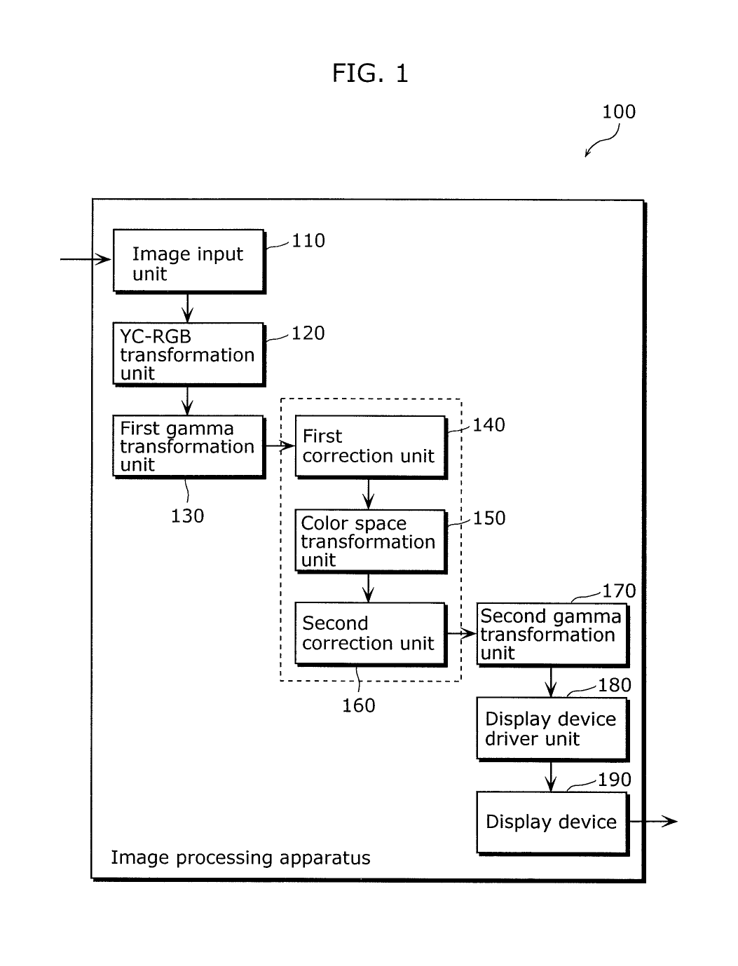

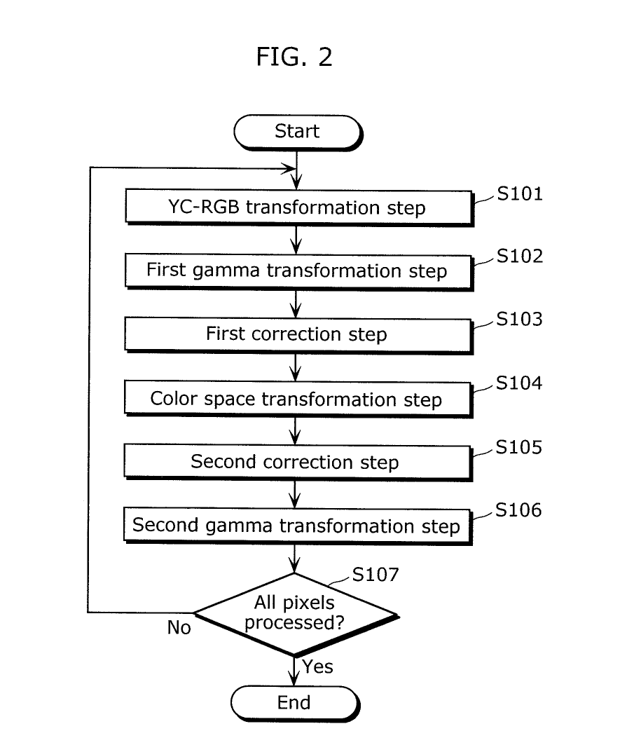

FIG. 1 is a block diagram of an image processing apparatus 100 according to Embodiment 1 of the present invention. FIG. 2 is a flowchart showing an operation of the image processing apparatus 100. The image processing apparatus 100 includes an image input unit 110, a YC-RGB transformation unit 120, a first gamma transformation unit 130, a first correction unit 140, a color space transformation unit 150, a second correction unit 160, a second gamma transformation unit 170, a display device driver unit 180, and a display device 190.

The image input unit 110 obtains an input signal and outputs the input signal to the YC-RGB transformation unit 120. In this example, the input signal is described as a Y/C signal which is made up of a luminance signal Y and chrominance signals Cb and Cr.

The YC-RGB transformation unit 120 transforms the Y/C signal obtained from the image input unit 110 into a color signal of a first color space which is defined by a standard such as BT.709 or sRGB (S101). In this example, the color signal of the first color space is described as a first RGB signal which is made up of a red component (R), a green component (G), and a blue component (B). The color value of each component making up the first RGB signal can take a value not only in the range from 0.0 to 1.0, but also a value larger than 1.0 or a negative value.

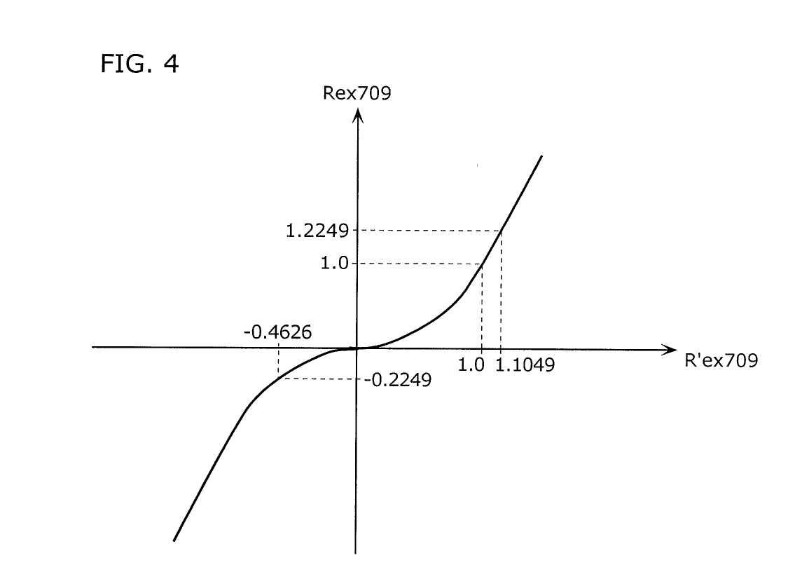

The first gamma transformation unit 130 performs, on the first RGB signal which has been input by the YC-RGB transformation unit 120, gamma transformation in compliance with a predetermined standard (for example, gamma transformation in compliance with the xvYCC standard) using a gamma transformation curve as shown in FIG. 4, and outputs a linearly-transformed first RGB signal (S102).

The first correction unit 140 performs first correction (clipping process) on the linear first RGB signal which has been output by the first gamma transformation unit 130 (S103). The first correction is a process, performed for each of the color values (R, G, B) making up the first RGB signal, of correcting (replacing) a color value exceeding a first upper limit to the first upper limit and correcting (replacing) a color value falling below a first lower limit to the first lower limit.

The color space transformation unit 150 transforms the first RGB signal (signal which is linear and has been clipped), which has been output by the first correction unit 140, into a color signal (second RGB signal) of a second color space defined according to display characteristics of the display device 190 (S104).

The second correction unit 160 performs second correction (clipping process) on the second RGB signal which has been output by the color space transformation unit 150 (S105). The second correction is a process, performed for each of the color values (R, G, B) making up the second RGB signal, of correcting (replacing) a color value exceeding a second upper limit to the second upper limit and correcting (replacing) a color value falling below a second lower limit to the second lower limit.

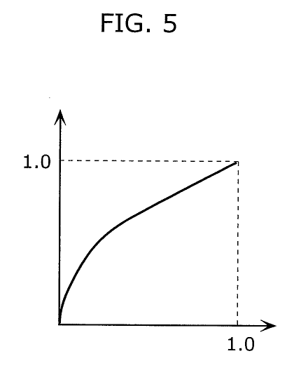

The second gamma transformation unit 170 performs, on the linear second RGB signal which has been output by the second correction unit 160, gamma transformation which is set according to the display characteristics of the display device 190, using a gamma transformation curve as shown in FIG. 5 (S106).

The display device driver unit 180 drives the display device 190 so that the display device 190 displays a color corresponding to the second RGB signal which has been output by the second gamma transformation unit 170. The image processing apparatus 100 performs the above processes (S101 to S106) on all pixels making up the input image (S107). It is to be noted that the above processes (S101 to S106) may be performed on a pixel-by-pixel basis or an image-by-image basis. Alternatively, some steps may be performed as one step on an image-by-image basis.

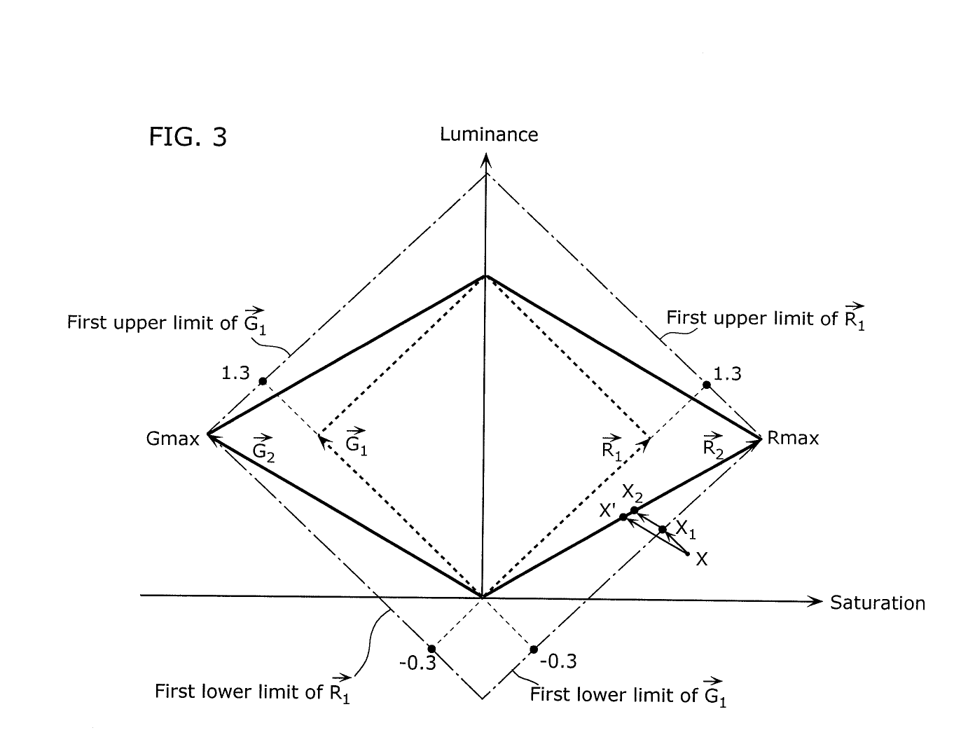

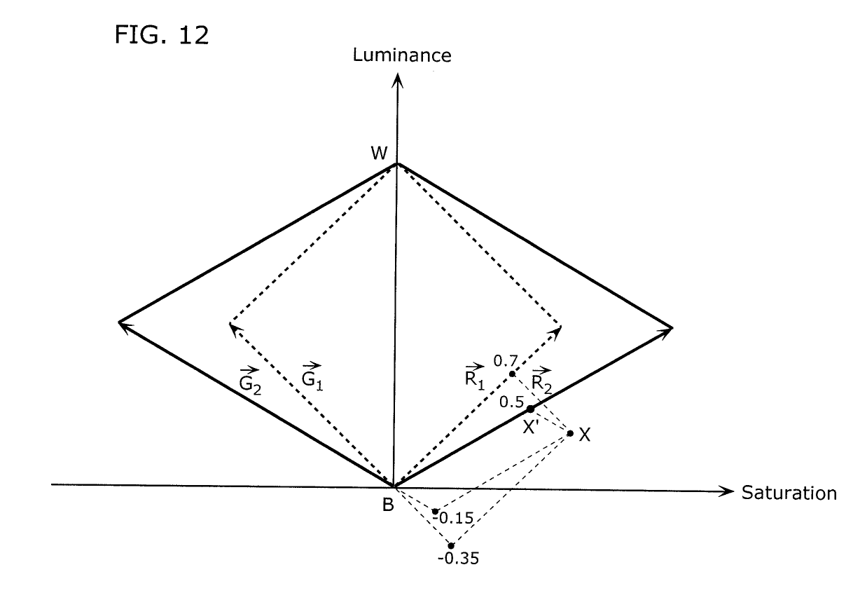

Next, with reference to FIG. 3, the processes of the image processing apparatus 100 (S103 to S105) are described in detail. FIG. 3 explains how the provision of the first correction unit 140, as shown in the image processing apparatus 100 according to Embodiment 1 of the present invention, leads to suppression of saturation drop in the color displayed by the display device 190. Here, the detailed descriptions of the aspects common to FIG. 12 are omitted.

First, the first correction (S103) is a process of transforming, for example, a color signal which corresponds to the point X expressed by the primary color vectors R₁^{→} and G₁^{→} of the first color space into a color signal which corresponds to the point X₁. More specifically, when the magnitudes of the primary color vectors R₁^{→} and G₁^{→} (color values) of the first color space expressing the point X exceed the first upper limit, the color values are corrected to (replaced with) the first upper limit, whereas when the color values fall below the first lower limit, they are corrected to (replaced with) the first lower limit.

It is to be noted that the first upper limit and the first lower limit are an upper limit and a lower limit necessary for expressing the color gamut of the second color space (region surrounded by solid lines) using the primary color vectors R₁^{→} and of the first color space. The example of FIG. 3 defines as follows:

First, the point Gₘₐₓ (R₂^{→}, G₂^{→})=(0.0, 1.0) located at the leftmost side of the color gamut of the second color space can be expressed as (R₁^{→}, G₁^{→})=(−0.3, 1.3) using the primary color vectors R₁^{→} and G₁^{→} of the first color space. Similarly, the point Rₘₐₓ (R₂^{→}, G₂^{→})=(1.0, 0.0) located at the rightmost side of the color gamut of the second color space can be expressed as (R₁^{→}, G₁^{→})=(1.3, −0.3) using the primary color vectors R₁^{→} and G₁^{→} of the first color space. That is to say, to express the color gamut of the second color space (region surrounded by solid lines) using the primary color vectors R₁^{→} and G₁^{→} of the first color space, it is sufficient to define the first upper limit and the first lower limit of the primary color vector R₁^{→} as −0.3≦R₁^{→}≦1.3 and the first upper limit and the first lower limit of the primary color vector G₁^{→} as −0.3≦G₁^{→}≦1.3 (indicated by alternate long and short dashed lines in FIG. 3).

It is to be noted that the region surrounded by the alternate long and short dashed lines in FIG. 3 is a rectangular region which can be obtained by moving each boundary line (broken line) of the color gamut of the first color space to a position parallel to itself in the outward direction (direction in which the color gamut becomes enlarged), and is the minimum region that includes the color gamut of the second color space (region surrounded by solid lines).

Then, by performing, using the above defined first upper limit (1.3) and first lower limit (−0.3), the first correction on the point X (R₁^{→}, G₁^{→})=(0.7, −0.35) expressed using the primary color vectors R₁^{→} and G₁^{→} of the first color space, the point X₁ (R₁^{→}, G₁^{→}) can be determined as (0.7, −0.3) (specifically, G₁^{→} is clipped to the first lower limit).

Next, the color space transformation (S104) is a process of re-expressing, using the primary color vectors R₂^{→} and G₂^{→} of the second color space, the point X₁ (R₁^{→}, G₁^{→})=(0.7, −0.3) expressed using the primary color vectors R₁^{→} and G₁^{→} of the first color space. The following describes the details. Initially, a color transformation matrix T is prepared in advance for mutual transformation of the primary color vectors R₁^{→} and G₁^{→} of the first color space and the primary color vectors R₂^{→} and G₂^{→} of the second color space. Then, the point X₁ (R₁^{→}, G₁^{→})=(0.7, −0.3) expressed using the primary color vectors R₁^{→} and G₁^{→} of the first color space is multiplied by the color transformation matrix T. This gives the point X₁ (R₂^{→}, G₂^{→})=(0.52, −0.2) expressed using the primary color vectors R₂^{→} and G₂^{→} of the second color space.

Next, the second correction (S105) is a process of transforming a color signal corresponding to the point X₁ expressed using the primary color vectors R₂^{→} and G₂^{→} of the second color space into a color signal corresponding to the point X₂. More specifically, when the magnitudes of the primary color vectors R₂^{→} and G₂^{→} (color values) of the second color space expressing the point X₁ exceed the second upper limit, the color values are corrected to (replaced with) the second upper limit, whereas when the color values fall below the second lower limit, they are corrected to (replaced with) the second lower limit. Here, it is sufficient to define the second upper limit and the second lower limit as values which can be displayed by the display device 190, namely, 0.0≦R₂^{→}≦1.0 and 0.0≦G₂^{→}≦1.0 (solid lines in FIG. 3).

Then, by performing, using the above-defined second upper limit (1.0) and second lower limit (0.0), the second correction on the point X₁ (R₂^{→}, G₂^{→})=(0.52, −0.2) expressed using the primary color vectors R₂^{→} and G₂^{→} of the second color space, the point X₂ (R₂^{→}, G₂^{→}) can be determined as (0.52, 0.0) (specifically, G₂^{→} is clipped to the second lower limit).

The point X₂ (R₂^{→}, G₂^{→})=(0.52, 0.0) determined by the above process indicates saturation higher than that of the point X′ (R₂^{→}, G₂^{→})=(0.5, 0.0) determined by the conventional method (that is to say, saturation drop from the original point X is suppressed).

Next, using Expressions 1 to 4, the following describes how the first upper limit and the second upper limit used in the first correction are determined for each color component (red component, green component, and blue component).

$$\begin{matrix}[ Math . 1 ] & \\ ( \begin{matrix}{R}_{dev} \\ {G}_{dev} \\ {B}_{dev}\end{matrix} ) = ( \begin{matrix}0.8225 & 0.1775 & 0.0000 \\ 0.0332 & 0.9668 & 0.0000 \\ 0.0171 & 0.0724 & 0.9105\end{matrix} ) ( \begin{matrix}{R}_{ex 709} \\ {G}_{ex 709} \\ {B}_{ex 709}\end{matrix} ) & ( Expression 1 )\end{matrix}$$

The 3×3 constant matrix shown in Expression 1 is the color transformation matrix T used for transforming the color signal (first RGB signal) of the first color space (first primary color) defined by a standard such as BT.709 into the color signal (second RGB signal) of the second color space (second primary color) defined according to the display characteristics of the display device 190.

In Expression 1, Rex709, Gex709, and Bex709 are color values making up the color signal (first RGB signal) of the first color space (corresponding to R₁^{→}) and G₁^{→} shown in FIG. 3 and B₁^{→} which is not shown), and each of the color values Rex709, Gex709, and Bex709 can take a value larger than 1.0 or a negative value. Further, Rdev, Gdev, and Bdev are color values making up the color signal (second RGB signal) of the second color space (corresponding to R₂^{→} and G₂^{→} shown in FIG. 3 and B₂^{→} which is not shown), and can take a value larger than 1.0 or a negative value. According to Expression 1, the second RGB signal (Rdev, Gdev, Bdev) is (0.8225, 0.0332, 0.0171) when the first RGB signal (Rex709, Gex709, Bex709) is (1.0, 0.0, 0.0).

$$\begin{matrix}[ Math . 2 ] & \\ ( \begin{matrix}{R}_{ex 709} \\ {G}_{ex 709} \\ {B}_{ex 709}\end{matrix} ) = ( \begin{matrix}1.2249 & - 0.2249 & 0.0000 \\ - 0.0421 & 1.0421 & 0.0000 \\ - 0.0196 & - 0.0786 & 1.0983\end{matrix} ) ( \begin{matrix}{R}_{dev} \\ {G}_{dev} \\ {B}_{dev}\end{matrix} ) & ( Expression 2 )\end{matrix}$$

Next, the 3×3 constant matrix shown in Expression 2 is an inverse matrix T′ of the color transformation matrix T shown in Expression 1. Here, the display device 190 is not capable of displaying color signals which fall within the ranges of 0.0≦Rdev≦1.0, 0.0≦Gdev≦1.0, and 0.0≦Bdev≦1.0 (that is to say, these values are the second upper limits and the second lower limits).

Thus, the first upper limit of Rex709 is 1.2249 (sum of the positive values in the first row of the inverse matrix T′) when the second RGB signal (Rdev, Gdev, Bdev) is (1.0, 0.0, 0.0) (corresponding to Rₘₐₓ in FIG. 3). The first lower limit of Rex709 is −0.2249 (sum of the negative values in the first row of the inverse matrix T′) when the second RGB signal (Rdev, Gdev, Bdev) is (0.0, 1.0, 0.0) (corresponding to Gₘₐₓ in FIG. 3). That is to say, in order to display all the color signals within the ranges of 0.0≦Rdev≦1.0, 0.0≦Gdev≦1.0, and 0.0≦Bdev≦1.0, the range of values possibly taken by Rex709 needs to be from −0.2249 to 1.2249. Conversely, the display device 190 cannot display, without any transformation, a color signal having the Rex709 value outside the range from −0.2249 to 1.2249.

Likewise, the first upper limit of Gex709 is 1.0421 (sum of the positive values in the second row of the inverse matrix T′), and the first lower limit of Gex709 is −0.0421 (sum of the negative values in the second row of the inverse matrix T′). Further, the first upper limit of Bex709 is 1.0983 (sum of the positive values in the third row of the inverse matrix T′), and the first lower limit of Bex709 is −0.0982 (sum of the negative values in the third row of the inverse matrix T′).

In other words, the first upper limit of each color value equals the sum of the positive values in the corresponding row of the inverse matrix T′, and the first lower limit of each color value equals the sum of the negative values in the corresponding row of the inverse matrix T′. The first upper limit and the first lower limit are determined for each of the color components (red component, green component, and blue component).

Using the above-determined first upper limits and first lower limits, a specific transformation process on the signal level is described. First, the image input unit 110 obtains a Y/C signal (Y, Cb, Cr)=(0.12, 0.12, −0.55), and outputs the Y/C signal to the YC-RGB transformation unit 120. Next, the YC-RGB transformation unit 120 transforms, using Expression 3 below, the Y/C signal obtained from the image input unit 110 into a first RGB signal having gamma characteristics (R′ex709, G′ex709, B′ex709)=(−0.7461, 0.3550, 0.3427), and outputs the first RGB signal having gamma characteristics to the gamma transformation unit 130.

$$\begin{matrix}[ Math . 3 ] & \\ ( \begin{matrix}{R}_{ex 709}^{′} \\ {G}_{ex 709}^{′} \\ {B}_{ex 709}^{′}\end{matrix} ) = ( \begin{matrix}1.0000 & 0.0000 & 1.5748 \\ 1.0000 & - 0.1873 & - 0.4681 \\ 1.0000 & 1.8556 & 0.0000\end{matrix} ) ( \begin{matrix}Y \\ Cb \\ Cr\end{matrix} ) & ( Expression 3 )\end{matrix}$$

The first gamma transformation unit 130 transforms the first RGB signal having gamma characteristics, which has been obtained from the YC-RGB transformation unit 120, into a linear first RGB signal (Rex709, Gex709, Bex709), and outputs the linear first RGB signal to the first correction unit 140. FIG. 4 shows an example of the gamma transformation curve used by the first gamma transformation unit 130.

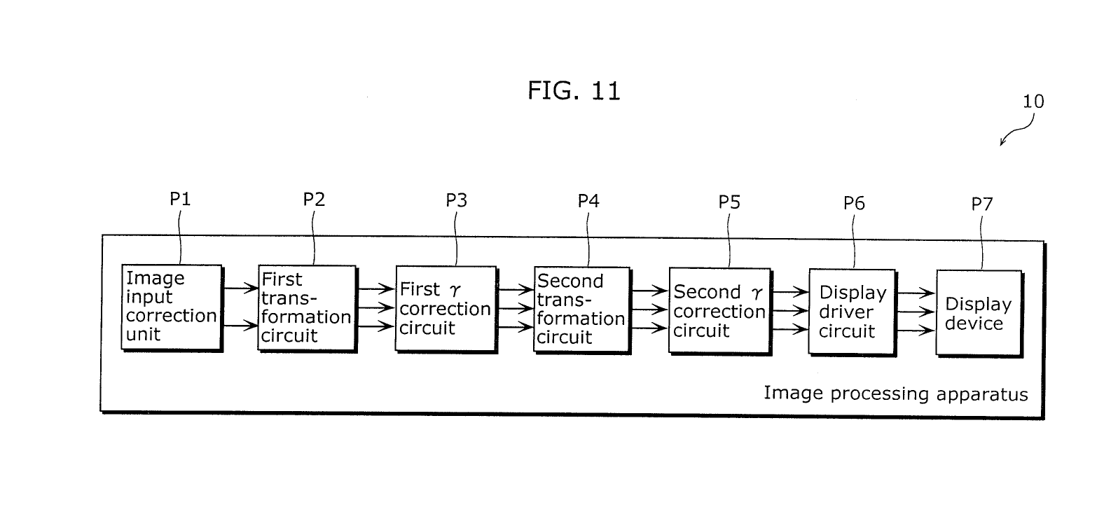

FIG. 4 shows a gamma transformation curve used for the red component transformation (transforming R′ex709 into Rex709). The horizontal axis represents the first RGB signal having gamma characteristics (R′ex709), and the vertical axis represents the gamma-transformed linear first RGB signal (Rex709). In the case of the xvYCC standard, for example, the positive portion of the gamma transformation curve is obtained by extending the BT.709 transformation curve such that the portion larger than 1.0 is included. The negative portion is point-symmetrical with the positive portion. Performing the gamma transformation in this example gives the linear first RGB signal (Rex709, Gex709, Bex709)=(−0.5578, 0.1402, 0.1319). Up to this process, both the conventional image processing apparatus 10 shown in FIG. 11 and the image processing apparatus 100 according to Embodiment 1 shown in FIG. 1 can achieve the same result.

The conventional image processing apparatus 10 shown in FIG. 11 does not include the first correction unit 140 shown in FIG. 1. Thus, the second transformation circuit P4 transforms the first RGB signal (Rex709, Gex709, Bex709) obtained by the above process into a second RGB signal (Rdev, Gdev, Bdev)=(−0.4339, 0.1170, 0.1207) using Expression 1. In addition, the second transformation circuit P4 clips each value of the obtained second RGB signal (Rdev, Gdev, Bdev) to a value between 0.0 to 1.0, and outputs the resulting second RGB signal (Rdev, Gdev, Bdev)=(0.0, 0.1170, 0.1207).

On the other hand, in the image processing apparatus 100 according to Embodiment 1 of the present invention shown in FIG. 1, the first correction unit 140 performs the process of clipping the first RGB signal (Rex709, Gex709, Bex709) to the first upper limit and the first lower limit, prior to the color space transformation by the color space transformation unit 150. More specifically, because the Rex 709 value (−0.5578) falls below the first lower limit (−0.2249); the first correction unit 140 clips Rex709 to the first lower limit, and outputs the first RGB signal (Rex709, Gex709, Bex709)=(−0.2249, 0.1402, 0.1319) to the color space transformation unit 150.

Next, the color space transformation unit 150 transforms the first RGB signal (Rex709, Gex709, Bex709), which has been obtained from the first correction unit 140, into the second RGB signal (Rdev, Gdev, Bdev)=(−0.1601, 0.1281, 0.1264) using Expression 1, and outputs the second RGB signal to the second correction unit 160. Then, the second correction unit 160 clips the second RGB signal (Rdev, Gdev, Bdev), which has been obtained from the color space transformation unit 150, to the second upper limit and the second lower limit (0.0 to 1.0), and outputs the resulting second RGB signal (Rdev, Gdev, Bdev)=(0.0, 0.1281, 0.1264) to the second gamma transformation unit 170. With this, the signal output by the second correction unit 160 according to Embodiment 1 has Gdev and Bdev, the values of which are larger than those of the signal output by the conventional second transformation circuit P4.

Moreover, with the image processing apparatus 100 according to Embodiment 1, the second gamma transformation unit 170 performs gamma transformation according to the display device 190, on the linear second RGB signal (Rdev, Gdev, Bdev) obtained from the second correction unit 160. FIG. 5 shows a second gamma transformation curve.

FIG. 5 shows a gamma transformation curve used for gamma-transforming the red component. The horizontal axis represents the linear second RGB signal (signal input to the second gamma transformation unit 170), and the vertical axis represents the second RGB signal having gamma characteristics (signal output from the second gamma transformation unit 170). In the example shown in FIG. 5, the gamma transformation curve is expressed as a power-of-(1/2.2) transformation equation, assuming that gamma of the display device 190 is 2.2. It is to be noted that the gamma transformation by the second gamma transformation unit 170 is preferably performed according to the gamma characteristics of the display device 190.

The second gamma transformation unit 170 performs the gamma transformation on the linear second RGB signal (Rdev, Gdev, Bdev) obtained from the second correction unit 160, and outputs the resulting second RGB signal having gamma characteristics (R′dev, G′dev, B′dev)=(0.0, 03929, 0.3906) to the display device driver unit 180. On the other hand, performing the gamma transformation using the gamma transformation curve in FIG. 5 on the linear second RGB signal (Rdev, Gdev, Bdev) output by the conventional second transformation circuit P4 gives the second RGB signal having gamma characteristics (R′dev, G′dev, B′dev)=(0.0, 03771, 0.3825).

$$\begin{matrix}[ Math . 4 ] & \\ ( \begin{matrix}Y \\ Cb \\ Cr\end{matrix} ) = ( \begin{matrix}0.2126 & 0.7152 & 0.0722 \\ - 0.1146 & - 0.3854 & 0.5000 \\ 0.5000 & - 0.4542 & - 0.0458\end{matrix} ) ( \begin{matrix}R \\ G \\ B\end{matrix} ) & ( Expression 4 )\end{matrix}$$

To demonstrate that the present invention suppresses the saturation drop, saturation is calculated by transforming the second RGB signal having gamma characteristics (R′dev, G′dev, B′dev) generated by the image processing apparatus 100 according to Embodiment 1 and the second RGB signal having gamma characteristics (R′dev, G′dev, B′dev) generated by the conventional image processing apparatus 10 into luminance and chrominance signals using the transformation equation in Expression 4.

First, using Expression 4, transforming the second RGB signal having gamma characteristics (R′dev, G′dev, B′dev)=(0.0, 03929, 0.3906) generated by the image processing apparatus 100 gives (Y, Cb, Cr)=(0.3092, 0.0439, −0.1964). Based on Cb and Cr, the saturation is calculated as 0.2012. On the other hand, using Expression 4, transforming the second RGB signal having gamma characteristics (R′dev, G′dev, B′dev)=(0.0, 03771, 0.3825) generated by the conventional image processing apparatus 10 gives (Y, Cb, Cr)=(0.2973, 0.0459, −0.1888). Thus, the saturation is calculated as 0.1943. This demonstrates that the method according to an implementation of the present invention suppresses the saturation drop.

### <Variation>

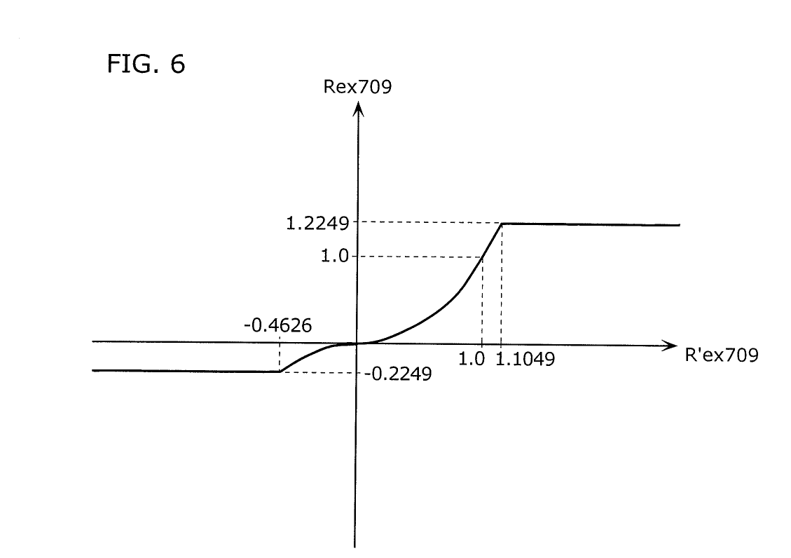

The following describes a variation of the image processing apparatus 100 according to Embodiment 1 of the present invention. In the block diagram of FIG. 1 showing the image processing apparatus 100 according to Embodiment 1 of the present invention, the first correction unit 140 may be provided with the function of the first gamma transformation unit 130. FIG. 6 is an explanatory diagram of a modified gamma transformation curve.

The gamma transformation curve shown in FIG. 6 matches the output value exceeding the first upper limit (1.2249) with the first upper limit, and matches the output value falling below the first lower limit (−0.2249) with the first lower limit. The first correction unit 140 according to the variation may perform the first correction simultaneously with the gamma transformation using the gamma transformation curve shown in FIG. 6.

With this structure, the output of the first correction unit 140 is a clipped first RGB signal. As a result, the first correction unit 140 and the first gamma transformation unit 130 do not need to be provided separately, thereby allowing reduction in the circuit scale.

In the case of providing a look-up table (LUT) as the first correction unit 140, there is an advantageous effect of reducing the number of bits of the table values.

### Embodiment 2

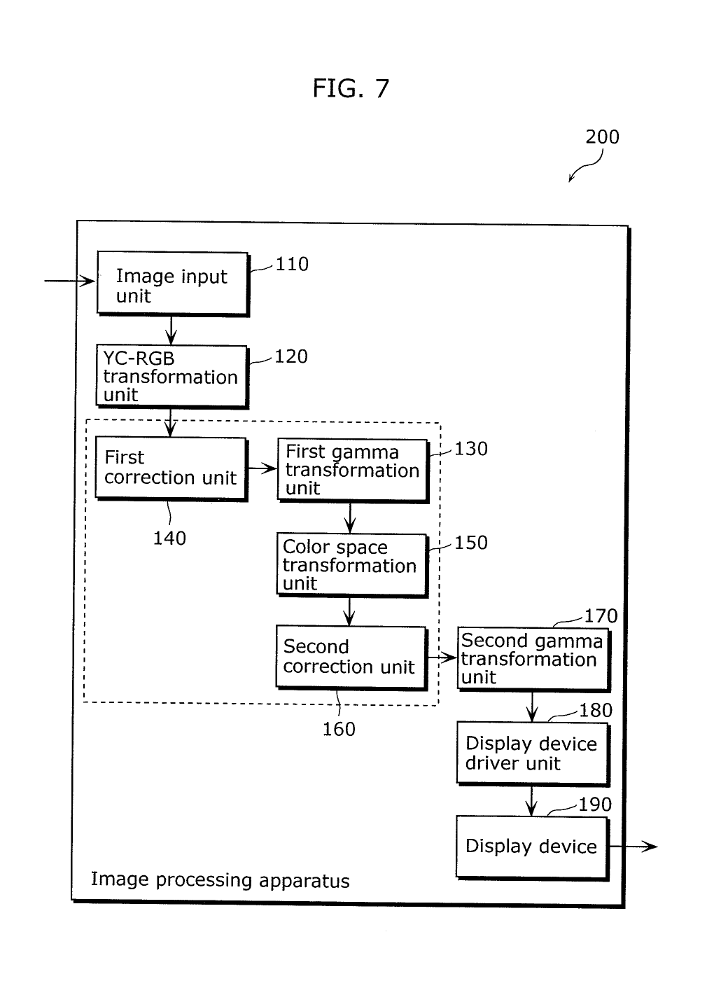

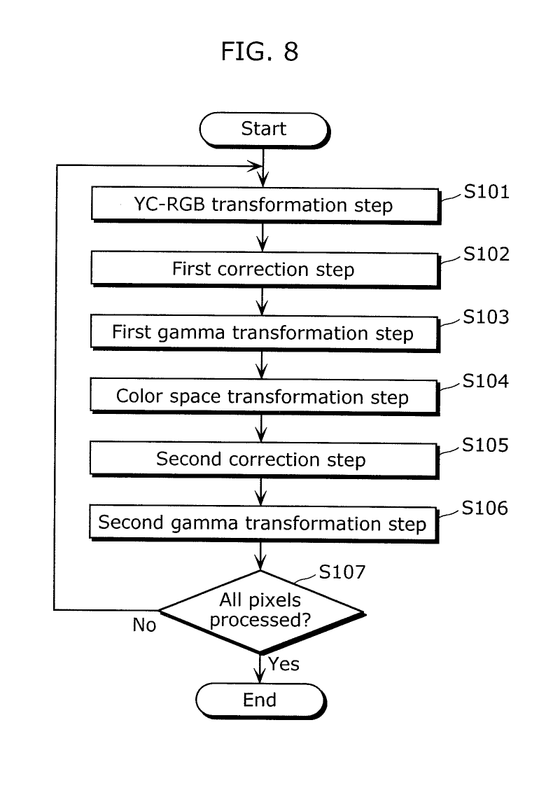

FIG. 7 is a block diagram of an image processing apparatus 200 according to Embodiment 2 of the present invention. FIG. 8 is a flowchart showing an operation of the image processing apparatus 200. The elements of FIGS. 7 and 8 that are common to FIGS. 1 and 2 are given the same reference numerals and detailed descriptions thereof are omitted.

The image processing apparatus 200 shown in FIG. 7 is different from the image processing apparatus 100 shown in FIG. 1 in order in which the first gamma transformation unit 130 and the first correction unit 140 perform the respective processes. More specifically, the first correction unit 140 is provided before the first gamma transformation unit 130. Thus, instead of performing the first correction (clipping process) on the linear first RGB signal on which the gamma transformation has been performed, the first correction (clipping process) is performed on the first RGB signal having gamma characteristics which is output by the YC-RGB transformation unit 120 and on which the gamma transformation has not yet been performed. In other words, instead of clipping the output signal of the first gamma transformation unit 130, the input signal of the first gamma transformation unit 130 is clipped.

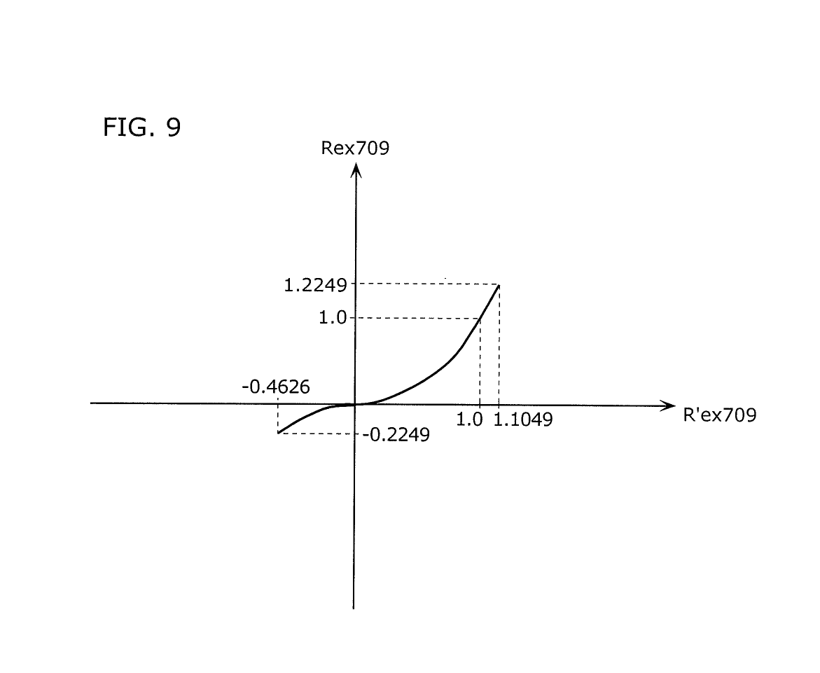

FIG. 9 is an explanatory diagram of a gamma transformation curve used by the first gamma transformation unit 130 according to Embodiment 2 of the present invention, and corresponds to FIG. 4 or FIG. 6. As in the image processing apparatus 100 according to Embodiment 1 of the present invention, performing the clipping process after the gamma transformation is equivalent to performing the clipping process on the linear first RGB signal. In other words, it is equivalent to clipping the values on the vertical axis of FIG. 9 (output values of the gamma transformation) to the first upper limit and the first lower limit.

On the other hand, as in the image processing apparatus 200 according to Embodiment 2 of the present invention, performing the clipping process prior to the gamma transformation is equivalent to performing the clipping process on the first RGB signal having gamma characteristics (non-linear RGB signal). In other words, it is equivalent to clipping the values on the horizontal axis of FIG. 9 (input values of the gamma transformation) to the first upper limit and the first lower limit.

In the case of determining the first upper limit and the first lower limit used in Embodiment 2, it is necessary to inversely perform the gamma transformation on the linear first upper limit and the linear first lower limit which are determined according to the method according to Embodiment 1. More specifically, it is sufficient to transform Rex709 (vertical axis) of FIG. 9 into R′ex709 (horizontal axis). In the example of FIG. 9, the first upper limit of Rex709 (1.2249) corresponds to the first upper limit of R′ex709 (1.1049). Likewise, the first lower limit of Rex709 (−0.2249) corresponds to the first lower limit of R′ex709 (−0.4626). Similarly, the first upper limit of G′ex709 is 1.0206, the first lower limit of G′ex709 is −0.1652, the first upper limit of B′ex709 is 1.0473, and the first lower limit of B′ex709 is −0.2878 (not shown).

According to this structure, since the clipping process is performed on the first RGB signal prior to the gamma transformation, there is an advantageous effect, in addition to the effect of Embodiment 1, that the signal range of the first RGB signal to be input to the first gamma transformation unit 130 can be limited in advance. As a result, it is possible to reduce the circuit scale of the image processing apparatus 200. For the red component, for example, the xvYCC standard defines a range from −1.1206 to 2.1305 as the input range of the possible first RGB signals having gamma characteristics, and the first gamma transformation unit 130 needs to have a circuit scale that supports that input range. On the other hand, according to Embodiment 2 of the present invention, performing the clipping process prior to the gamma transformation makes it possible to limit the input range of the first RGB signal having gamma characteristics to a range from −0.4626 to 1.1049. This means that the input range of the signal to be input to the first gamma transformation unit 130 can be reduced to a half of or less than a half of the input range of Embodiment 1.

### Embodiment 3

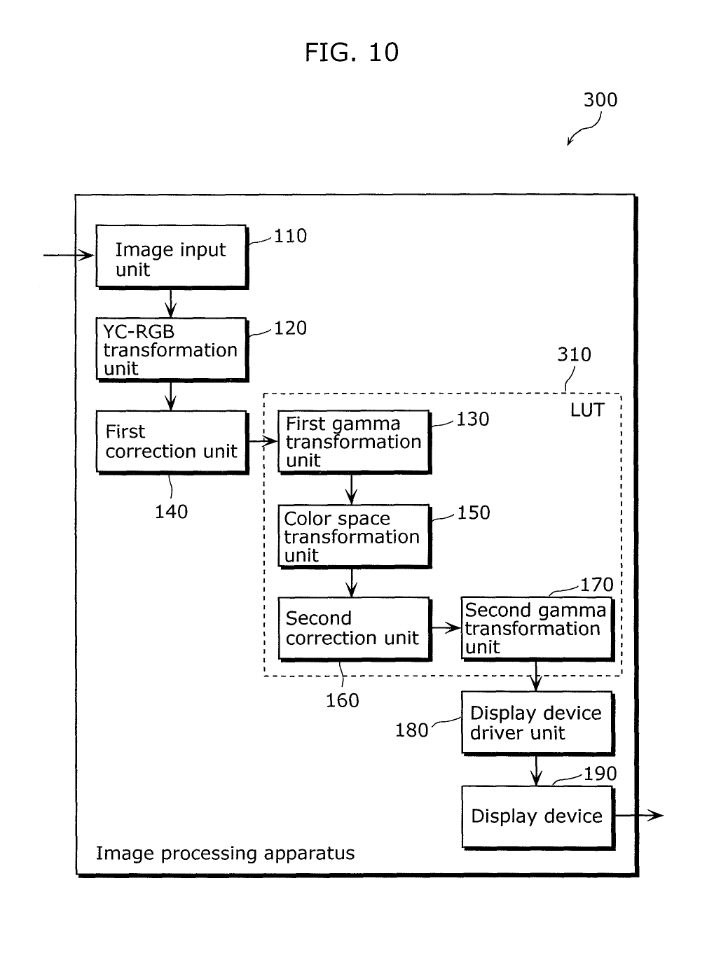

FIG. 10 is a block diagram of an image processing apparatus 300 according to Embodiment 3 of the present invention. The constituent elements of FIG. 10 that are same as those in the image processing apparatuses 100 and 200 shown in FIGS. 1 and 7 are given the same reference numerals, and detailed descriptions thereof are omitted.

The image processing apparatus 300 shown in FIG. 10 is different from the image processing apparatus 200 shown in FIG. 7 in that the first gamma transformation unit 130, the color space transformation unit 150, the second correction unit 160, and the second gamma transformation unit 170 are implemented by a LUT 310. An advantageous effect of employing the LUT 310 is that the implementation is possible while achieving processing-time reduction and performing other color processing such as a simple memory color correction.

According to this structure, since the clipping process is performed on the first RGB signal before the first RGB signal is input into the LUT 310, there is an advantageous effect, in addition to the effect of Embodiment 1, that the signal range of the first RGB signal to be input to the LUT 310 can be limited in advance. As a result, the size of the LUT 310 can be reduced, thereby allowing reduction in the circuit scale. For the red component, for example, the xvYCC standard defines a range from −1.1206 to 2.1305 as the input range of the possible first RGB signals having gamma characteristics, and the first gamma transformation unit 130 needs to have a circuit scale that supports that input range. On the other hand, according to Embodiment 3 of the present invention, performing the clipping process prior to the gamma transformation makes it possible to limit the input range of the first RGB signal having gamma characteristics to a range from −0.4626 to 1.1049. This means that the input range of the signal to be input to the LUT 310 can be reduced to a half of or less than a half of the input range of Embodiment 1. In addition, in the case of implementing the processes through three-dimensional LUT interpolation, it is possible to divide the gamma transformation curve more finely, given that the number of the tables is the same. Therefore, increase in the processing precision can be expected.

In Embodiment 3, the first upper limit and the first lower limit used by the first correction unit 140 may be determined through an exact inverse transformation of the processes of the LUT 310. However, if an exact inverse transformation is difficult, an approximate inverse transformation may be performed instead.

Although FIG. 3 has shown the case of two primary colors (two dimensions) of the red component (R) and the green component (G) for the purpose of simplifying the description, the same advantageous effect can be obtained even in the case of three primary colors (three dimensions) including the blue component (B).

Further, although the YC-RGB transformation unit 120 (YC-RGB transformation step) according to each of the above embodiments uses Expression 3 to transform the Y/C signal, which is made up of luminance and chrominance signals, into the first RGB signal made up of the red component, the green component, and the blue component, the present invention is not limited to the use of Expression 3. For example, it is possible to transform, into the first RGB signal, an RGB signal defined by a transformation equation in accordance with BT.601 or JPEG, or by a specific primary color. Further, the input signal does not have to be a Y/C signal made up of luminance and chrominance signals, and may be the first RGB signal from the beginning.

Furthermore, although each of the above embodiments is provided with the second gamma transformation unit 170 (second gamma transformation step) which performs the gamma transformation according to the display characteristics of the display device 190, the second gamma transformation unit 170 (second gamma transformation step) may be omitted in the case where the display device 190 outputs linear RGB signals. Moreover, the second correction unit 160 (second correction step) may be included in the color space transformation unit 150 (color space transformation step), the second gamma transformation unit 170 (second gamma transformation step), or the display device driver unit 180.

In addition, although the first upper limit and the first lower limit used by the first correction unit 140 (first correction step) are determined based on the matrix components (each component in the inverse matrix T′) used by the color space transformation unit 150 (color space transformation step), the first upper limit and the first lower limit are not limited to such values. For example, the first lower limit is sufficient as long as it is smaller than the value determined based on the matrix components. Likewise, the first upper limit is sufficient as long as it is larger than the value determined based on the matrix components.

Further, although a different first upper limit is determined for each color component (RGB), the same first upper limit may be used for all the color components (RGB). The same holds true for the first lower limit. For example, the smallest value among three first lower limits of the color components (RGB) may be determined as the first lower limit common to all the RGB components, and the largest value among three first upper limits of the color components (RGB) may be determined as the first upper limit common to all the RGB components.

Furthermore, although the embodiments of the present invention have described the image processing according to the present invention as processing performed within plasma displays, liquid crystal displays, and so on, the image processing according to the present invention may be implemented on the imaging device side or in a transmission device. In the case where a color matching unit or a linear color transformation unit is not included on the display device 190 side, YC-RGB-transformed signals having values that are negative or larger than 1 cannot be displayed. However, in the case where the primary colors of the display device 190 are known in advance, it is possible to generate, before the signals are input into the display device 190, signals the values of which do not become negative or larger than 1 in the YC-RGB transformation unit 120. In other words, the signal values can be clipped in advance on the imaging device side or in the transmission device, using the method according to the present invention.

It is to be noted that the application of the present invention is not limited to TVs, but the present invention may also be applied to appliances and systems having a display (for example, cameras, video cameras, mobile phones, and car navigation systems).

### (Other Variations)

Although the present invention has been described based on the embodiments above, the present invention is certainly not limited to such embodiments. The present invention also includes such cases as below.

Each of the above-described apparatuses is specifically a computer system including a microprocessor, a ROM, a RAM, a hard disk unit, a display unit, a keyboard, a mouse, and so on. In the RAM or the hard disk unit, a computer program is stored. As the microprocessor operates according to the computer program, each apparatus implements its function. Here, the computer program is a combination of several instruction codes indicating commands for a computer to perform in order to implement a predetermined function.

The constituent elements of each of the above-described apparatuses may be partially (for example, the portion surrounded by broken lines in each block diagram) or entirely configured as a single system Large Scale Integration (LSI). The system LSI is a super-multifunctional LSI manufactured as one chip on which multiple constituent elements are integrated, and is specifically a computer system including a microprocessor, a ROM, a RAM, and so on. In the RAM, a computer program is stored. As the microprocessor operates according to the computer program, the system LSI implements its function.

The constituent elements of each of the above-described apparatuses may be partially (for example, the portion surrounded by broken lines in each block diagram) or entirely configured as a single module or an IC card insertable to the apparatus. The IC card or the module is specifically a computer system including a microprocessor, a ROM, a RAM, and so on. The IC card or the module may include the above-described super-multifunctional LSI. As the microprocessor operates according to the computer program, the IC card or the module implements its function. The IC card or the module may be tamper-resistant.

The present invention may be implemented as the above-described methods. In addition, the present invention may be implemented as a computer program which causes a computer to execute such methods or as a digital signal which includes a computer program.

The present invention can also be implemented as a computer-readable recording medium, such as a flexible disk, a hard disk, a CD-ROM, MO, DVD, DVD-ROM, DVD-RAM, BD (Blu-ray disc), or a semiconductor memory, on which a computer program or a digital signal is recorded. Further, the present invention may be implemented as a digital signal recorded on such recording media.

Furthermore, the present invention may be implemented as a transmission device which transmits a computer program or a digital signal via a telecommunication line, a wireless or wired communication line, a network represented by the Internet, a data broadcast, and so on.

Moreover, the present invention may be implemented as a computer system including a microprocessor and a memory, whereby the above-described computer program is stored in the memory, and the microprocessor operates according to the computer program.

In addition, the present invention may be implemented by another independent computer system after transmitting, to the other independent computer system, a program or a digital signal recorded in a recording medium, or after transmitting, to the other independent computer system, a program or a digital signal via a network or the like.

The above embodiments and variations may be combined.

Although embodiments of the present invention have been described with reference to the drawings, the present invention is not limited to the embodiments shown in the drawings. It is possible to make various modifications and variations of the embodiments shown in the drawings without materially departing from a scope identical to or equivalent to the scope of the present invention.

### INDUSTRIAL APPLICABILITY

The image processing apparatus and the image processing method according to the present invention are useful in processing such as color transformation for plasma displays and liquid crystal displays, because they can suppress saturation drop to an extent greater than in the case of only clipping to color signals of the display device, and can reduce the circuit scale of the gamma transformation circuit and the look-up table in the case of receiving input of an image signal the value of which is negative or greater than 1.

What is claimed is:

1. An image processing apparatus which transforms a color signal of a first color space defined by a predetermined standard into a color signal of a second color space which is defined according to display characteristics of a display device and has a color gamut wider than a color gamut of the first color space, and outputs the transformed color signal, said image processing apparatus comprising:
a first correction unit configured to, for each of color values making up the color signal of the first color space, correct a color value exceeding a first upper limit to the first upper limit and correct a color value falling below a first lower limit to the first lower limit, the first upper limit and the first lower limit being necessary for expressing the color gamut of the second color space;
a color space transformation unit configured to transform the color signal of the first color space corrected by said first correction unit, into the color signal of the second color space; and
a second correction unit configured to, for each of color values making up the color signal of the second color space generated by said color space transformation unit, (i) correct a color value exceeding a second upper limit to the second upper limit and correct a color value falling below a second lower limit to the second lower limit, and (ii) output the corrected values, the second upper limit and the second lower limit being values which can be displayed by the display device.

2. The image processing apparatus according to claim 1, further comprising
a gamma transformation unit configured to perform, based on a gamma transformation curve determined in accordance with the predetermined standard, gamma transformation on the color signal of the first color space corrected by said first correction unit,
wherein said color space transformation unit is configured to transform the color signal of the first color space, on which said gamma transformation unit has performed the gamma transformation, into the color signal of the second color space.

3. The image processing apparatus according to claim 1,
wherein said first correction unit is configured to simultaneously perform gamma transformation and correct the color values making up the color signal of the first color space, the gamma transformation being performed using a gamma transformation curve which is determined in accordance with the predetermined standard and which matches an output value exceeding the first upper limit with the first upper limit and matches an output value falling below the first lower limit with the first lower limit.

4. The image processing apparatus according to claim 1, further comprising
a gamma transformation unit configured to perform gamma transformation on the color signal of the first color space based on a gamma transformation curve determined in accordance with the predetermined standard,
wherein said first correction unit is configured to correct the color values making up the color signal of the first color space on which said gamma transformation unit has performed the gamma transformation.

5. The image processing apparatus according to claim 1,
wherein the color signal of the first color space and the color signal of the second color space are expressed using primary color vectors each corresponding to one of the color values, and
the first upper limit and the first lower limit are an upper limit and a lower limit of each of the primary color vectors of the first color space, the upper limit and the lower limit being necessary for combining the primary color vectors of the first color space so as to express each of the primary color vectors of the second color space.

6. The image processing apparatus according to claim 1,
wherein said color space transformation unit is configured to transform the color signal of the first color space into the color signal of the second color space using a color transformation matrix determined according to the display characteristics of the display device, and
the first upper limit and the first lower limit are determined based on an inverse matrix of the color transformation matrix.

7. The image processing apparatus according to claim 6,
wherein the first upper limit and the first lower limit are determined for each of a red component, a green component, and a blue component which make up the color values.

8. The image processing apparatus according to claim 7,
wherein the first upper limit is a sum of positive components in a row of the inverse matrix, and
the first lower limit is a sum of negative components in a row of the inverse matrix.

9. An image processing method of transforming a color signal of a first color space defined by a predetermined standard into a color signal of a second color space which is defined according to display characteristics of a display device and has a color gamut wider than a color gamut of the first color space, and outputting the transformed color signal, said image processing method comprising:
for each of color values making up the color signal of the first color space, correcting a color value exceeding a first upper limit to the first upper limit and correcting a color value falling below a first lower limit to the first lower limit, the first upper limit and the first lower limit being necessary for expressing the color gamut of the second color space;
transforming the color signal of the first color space corrected in said correcting, into the color signal of the second color space; and
for each of color values making up the color signal of the second color space generated in said transforming, correcting a color value exceeding a second upper limit to the second upper limit and correcting a color value falling below a second lower limit to the second lower limit, and outputting the corrected values, the second upper limit and the second lower limit being values which can be displayed by the display device.

10. A computer-readable recording medium on which a program is recorded which causes a computer to transform a color signal of a first color space defined by a predetermined standard into a color signal of a second color space which is defined according to display characteristics of a display device and has a color gamut wider than a color gamut of the first color space, and to output the transformed color signal, the program causing the computer to execute:
for each of color values making up the color signal of the first color space, correcting a color value exceeding a first upper limit to the first upper limit and correcting a color value falling below a first lower limit to the first lower limit, the first upper limit and the first lower limit being necessary for expressing the color gamut of the second color space;
transforming the color signal of the first color space corrected in said correcting, into the color signal of the second color space; and
for each of color values making up the color signal of the second color space generated in said transforming, correcting a color value exceeding a second upper limit to the second upper limit and correcting a color value falling below a second lower limit to the second lower limit, and outputting the corrected values, the second upper limit and the second lower limit being values which can be displayed by the display device.

11. An integrated circuit which transforms a color signal of a first color space defined by a predetermined standard into a color signal of a second color space which is defined according to display characteristics of a display device and has a color gamut wider than a color gamut of the first color space, and outputs the transformed color signal, said integrated circuit comprising:
a first correction unit configured to, for each of color values making up the color signal of the first color space, correct a color value exceeding a first upper limit to the first upper limit and correct a color value falling below a first lower limit to the first lower limit, the first upper limit and the first lower limit being necessary for expressing the color gamut of the second color space;
a color space transformation unit configured to transform the color signal of the first color space corrected by said first correction unit, into the color signal of the second color space; and
a second correction unit configured to, for each of color values making up the color signal of the second color space generated by said color space transformation unit, (i) correct a color value exceeding a second upper limit to the second upper limit and correct a color value falling below a second lower limit to the second lower limit, and (ii) output the corrected values, the second upper limit and the second lower limit being values which can be displayed by the display device.
